(19) United States
(12) Patent Application Publication
(10) Pub. No.: US 2013/0140266 A1
(43) Pub. Date: Jun. 6, 2013

(54) IN-MOLD ROLLER MANUFACTURING METHOD AND CASING PRODUCT MADE THEREBY

(71) Applicants: MING-HUNG HUANG, Tainan Hsien (TW); SHUN-CHENG WANG, Tainan Hsien (TW); KUN-MOU YANG, Tainan Hsien (TW); KIN-SEN CHANG, Tainan Hsien (TW)

(72) Inventors: MING-HUNG HUANG, Tainan Hsien (TW); SHUN-CHENG WANG, Tainan Hsien (TW); KUN-MOU YANG, Tainan Hsien (TW); KIN-SEN CHANG, Tainan Hsien (TW)

(21) Appl. No.: 13/753,528

(22) Filed: Jan. 30, 2013

Related U.S. Application Data
(62) Division of application No. 12/947,838, filed on Nov. 17, 2010.

(51) Int. Cl. B29C 45/14

(52) U.S. Cl. CPC B29C 45/1418
USPC 216/9; 264/266; 264/446

(57) ABSTRACT

An in-mold roller (IMR) manufacturing method is provided, including the following steps: providing a forming mold, which includes a female mold member and a male mold member mating the female mold member, the female mold member being provided with a pattern structure; providing an IMR film to an injection molding machine; providing an injectionable material; depositing the injectionable material and the IMR film in the forming mold; and performing injection molding operation to mold a casing carrying texture corresponding to the pattern structure. A casing manufactured with the IMR manufacturing method is also provided.

### CROSS-REFERENCE TO RELATED APPLICATION

This is a division of the co-pending patent application Ser. No. 12/947,838, filed Nov. 17, 2010.

### (a) TECHNICAL FIELD OF THE INVENTION

The present invention generally relates to an in-mold roller (Mt) manufacturing method for a forming mold of in-mold injection, and more particularly to a casing product having the feel of leather that is made with an IMR manufacturing method for forming mold of in-mold injection.

### (b) DESCRIPTION OF THE PRIOR ART

A forming technology with in-mold injection employs a technique that transfers inks or patterns containing a curable layer to a casing or shell. However, in the conventional in-mold injection process, the curable layer forms protection for the surface of the casing or shell after the transfer printing. Since the curable layer provides a smooth and flat surface, it is hard to provide an outside structure or feel appealed to the consumers, thereby reducing the desire of purchasing of the consumers.

The known products (such as 3C products, including mobile phones, notebook computers, and computer mice) having leather feel available in the market are most made with in-mold lamination or spraying leather paint. However, the application of in-mold lamination is limited due to the characteristics of scratching resistance and temperature resistance of the leather material itself. Further, the thermal shaping and preciseness of cutting of the leather often lead to incorrect size of the product. In addition, the location of sprue and the configuration runner must be carefully designed for material injection in order to eliminate the potential risk of breaking leather. On the other hand, if spraying leather paint is adopted, environmental pollution may easily be caused. Further, the quality of spraying work and the drying process of the sprayed paint add the economic burden of manufacturing costs, limiting the application thereof.

Thus, it is desired to have a manufacturing method that is suitable for manufacturing a casing product showing an appearance and feel of specific pattern or texture structure (such as leather).

### SUMMARY OF THE INVENTION

An objective of the present invention is to provide an in-mold roller (IMR) manufacturing method for forming mold of in-mold injection, which makes a casing product showing an appearance and feel of leather and eliminates the drawbacks of the conventional processes due to the constraint imposed by the characteristics of leather or environmental pollution or increased costs of spraying leather paint.

To achieve the above objective, according to the present invention, an IMR manufacturing method is provided, comprising the following steps: providing a forming mold, which comprises a female mold member and a male mold member mating the female mold member, the female mold member being provided with a pattern structure; providing an IMR film to an injection molding machine; providing an injectionable material; depositing the injectionable material and the IMR film in the forming mold; and performing injection molding operation to mold a casing carrying texture corresponding to the pattern structure.

According to the manufacturing method of the present invention, the injectionable material is not limited to a single substance and can alternatively be a combination of multiple substances, preferably a substance selected from a group consisting of silicon rubber, plastic, and rubber. Specifically, the injectionable material is a substance selected from a group consisting of polyvinyl chloride, polyethylene terephthalate, polycarbonate, acrylonitrile-styrene-butadiene copolymer, polyimide, polyether imide, polyphenylene sulfide, polysulfone, polystyrene, acelene glycol modified polyester, and polypropylene polymer.

Further, according to the manufacturing method of the present invention, the pattern structure is formed with electric discharge machining or chemical etching.

Further, in the manufacturing method of the present invention, the IMR film is made by coating resin containing multiple dispersed particles on a composite base material layer and further applying a release layer, a leather paint layer, an ink layer, and an adhesive layer thereto, to be eventually subjected to an injection molding operation with a plastic material to form a casing product. In other words, the IMR film according to the present invention comprises a composite base material layer, a release layer, a leather paint layer, an ink layer, and an adhesive layer. Thus, according to the present invention, an improved large R-angle coverage can be formed as compared to the prior art technology.

To make the manufacturing method of the present invention closer to the feel of leather, at least one solid particle is added to the release layer, wherein the particle is made of wax, silicon dioxide, titanium dioxide, or a combination thereof and has a particle size ranging from 1-15 μm, preferably 3-10 μm.

The present invention also provides a casing manufactured with the IMR manufacturing method described above, wherein the casing comprises a texture structure, which is formed through a forming mold of injection molding, the forming mold comprising a female mold member and a male mold member mating the female mold member, the female mold member carrying a pattern structure corresponding to the texture structure; and an IMR film, which comprises a composite base material layer, a release layer, a leather paint layer, an ink layer, and an adhesive layer; wherein to make the casing manufactured with the manufacturing method of the present invention closer to the feel of leather, at least one solid particle is added to the release layer, wherein the particle is made of wax, silicon dioxide, titanium dioxide, or a combination thereof and has a particle size ranging from 1-15 μm, preferably 3-10 μm.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic cross-sectional view showing a casing product and an in-mold roller film according to the present invention.

FIG. 2 is a flow chart of a manufacturing method according to a preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

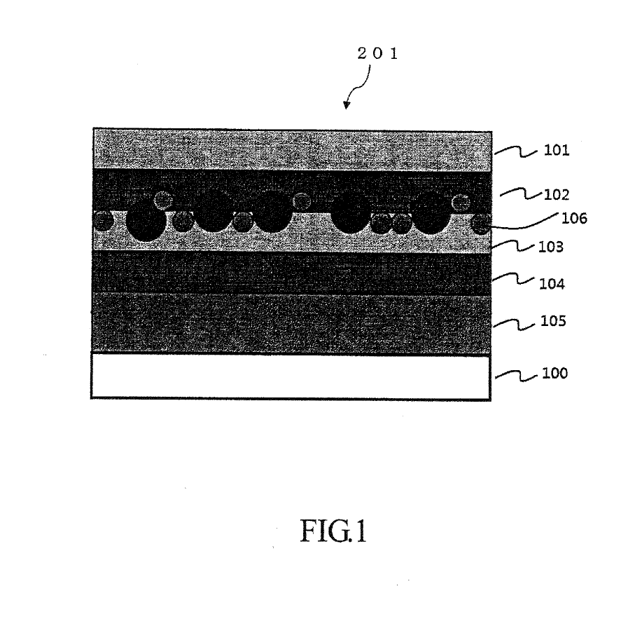

As shown in FIG. 1, a casing product, generally designated at 100, manufacturing with a method according to the present invention comprises an in-mold roller (IMR) film 201 attached thereto. The IMR film 201 comprises a composite base material layer 101, a release layer 102, a leather paint layer 103, an ink layer 104, and an adhesive layer 105. To make the casing product manufacturing with the method according to the present invention feel much closer to leather, at least one solid particle 106 is added in the release layer 102, wherein the solid particle 106 can be made of wax, silicon dioxide, titanium dioxide, nano-size calcium carbonate, or a combination thereof.

The method according to the present invention will be described as follows.

### Embodiment I

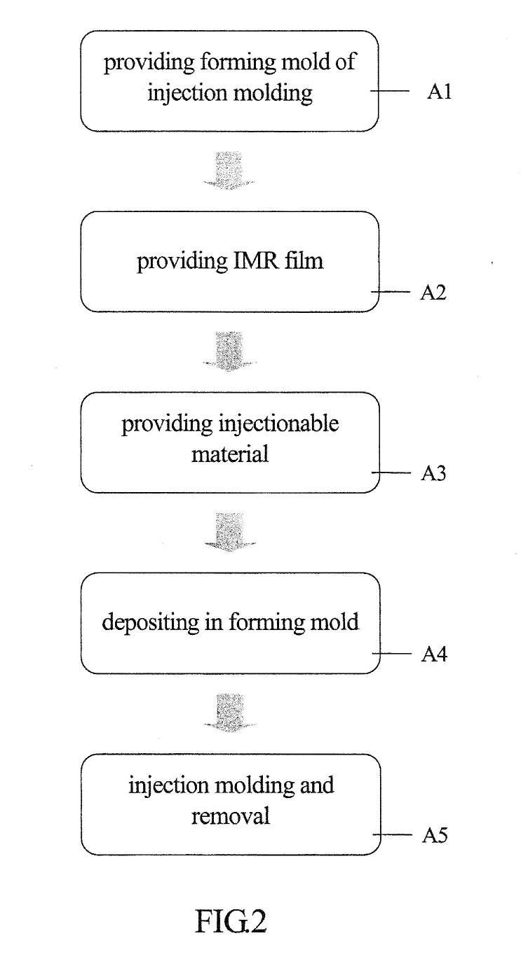

Reference is also made to FIG. 2, which shows a flow chart of the method of the present invention.

Firstly, in Step A1, a forming mold for injection molding is provided. The forming mold consists of a female mold member and a male mold member mating the female mold member. The female mold member is provided with a pattern or texture structure. Specifically, the forming mold is selected and modified according to the shape and/or structure of the casing product to be manufactured. In the instant embodiment, to manufacture a casing product carrying leather texture, the female mold member is partly subjected to a texture forming operation to form a desired pattern. The pattern or texture can be formed with for example chemical etching process (such as weak corrosion caused by chemical solutions on a surface of the forming mold), or electric discharge machining.

Then, in Steps A2 and A3, an IMR film is provided to an injection molding machine, wherein the IMR film is made by coating resin containing multiple dispersed particles on a composite base material layer and further applying a release layer, a leather paint layer, an ink layer, and an adhesive layer thereto, to be eventually subjected to an injection molding operation with a plastic material to form a casing product. In other words, the IMR film according to the instant embodiment comprises a composite base material layer, a release layer, a leather paint layer, an ink layer, and an adhesive layer. Thus, according to the instant embodiment, an improved large R-angle coverage can be formed as compared to the prior art technology.

To make the manufacturing method of the instant embodiment closer to the feel of leather, at least one solid particle is added to the release layer, wherein the particle is made of wax, silicon dioxide, titanium dioxide, nano-size calcium carbonate, or a combination thereof and has a particle size ranging from 1-15 μm, preferably 3-10 μm.

Afterwards, an injectionable material is provided. The injectionable material is not limited to a single substance and can alternatively be a combination of multiple substances, preferably a substance selected from a group consisting of silicon rubber, plastic, and rubber. Specifically, the injectionable material is a substance selected from a group consisting of polyvinyl chloride, polyethylene terephthalate, polycarbonate, acrylonitrile-styrene-butadiene copolymer, polyimide, polyether imide, polyphenylene sulfide, polysulfone, polystyrene, acelene glycol modified polyester, and polypropylene polymer.

In Step A4, the injectionable material provided in Step A3 is injected, with the IMR film provided in Step A2 deposited in the forming mold provided in Step A1, to get ready for performance of injection molding operation for molding a casing product having a desired shape and/or structure. Finally, in Step A5, the injection molding is properly performed, and the casing product so molded is removed from the forming mold to thereby complete a casing having leather texture structure according to the instant embodiment.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An in-mold roller (IMR) manufacturing method, which is adapted to serve as a forming mold for in-mold injection, the method comprising the following steps:
providing a forming mold, which comprises a female mold member and a male mold member mating the female mold member, the female mold member being provided with a pattern structure;
providing an IMR film to an injection molding machine;
providing an injectionable material;
depositing the injectionable material and the IMR film in the forming mold; and
performing injection molding operation to mold a casing carrying texture corresponding to the pattern structure.

2. The method according to claim 1, wherein the injectionable material is selected from a group consisting of silicon rubber, plastic, and rubber.

3. The method according to claim 1, wherein the injectionable material is selected from a group consisting of polyvinyl chloride, polyethylene terephthalate, polycarbonate, acrylonitrile-styrene-butadiene copolymer, polyimide, polyether imide, polyphenylene sulfide, polysulfone, polystyrene, acelene glycol modified polyester, and polypropylene polymer.

4. The method according to claim 1, wherein the pattern structure is formed with electric discharge machining or chemical etching.

5. The method according to claim 1, wherein the IMR film comprises a composite base material layer, a release layer, a leather paint layer, an ink layer, and an adhesive layer.

6. The method according to claim 5, wherein the release layer comprises at least a solid particle added therein.

7. The method according to claim 6, wherein the solid particle is made of wax, silicon dioxide, titanium dioxide, or a combination thereof.

8. The method according to claim 6, wherein the solid particle has a particle size ranging from 1-15 μm.

9. The method according to claim 6, wherein the solid particle has a particle size ranging from 3-10 μm.
